(19) United States
(12) Patent Application Publication
(10) Pub. No.: US 2017/0061374 A1
(43) Pub. Date: Mar. 2, 2017

(54) Spare Parts List Builder and Compiler Tools and Methods of Use

(71) Applicant: Toyota Motor Engineering & Manufacturing North America, Inc., Erlanger, KY (US)

(72) Inventor: Alexander Anderson, Lexington, KY (US)

(73) Assignee: Toyota Motor Engineering & Manufacturing North America, Inc., Erlanger, KY (US)

(21) Appl. No.: 14/833,282

(22) Filed: Aug. 24, 2015

(51) Int. Cl. G06Q 10/08; G06F 3/0484

(52) U.S. Cl. CPC G06Q 10/0875; G06F 3/0484

(57) ABSTRACT

Methods and systems for standardizing spare parts lists including uploading one or more spare parts lists to a central portal; standardizing the one or more spare parts lists via the central portal, wherein the access to a standardizing level of the portal is associated with an advanced security clearance level; storing the one or more standardized spare parts lists in a database; releasing the one or more standardized spare parts lists; displaying the one or more standardized spare parts lists on a graphical user interface communicatively coupled to the central portal; and displaying a first asset to inventory ratio report over a period of time of an asset to inventory ratio based at least in part on data from the standardized one or more spare parts lists for at least one of an industrial manufacturing site and a plurality of industrial manufacturing sites.

### TECHNICAL FIELD

The present specification generally relates to application tools to build and compile lists and, more specifically, to application tools to build, compile, and store standardized spare parts list(s) across manufacturing environments and methods of use of such tools.

### BACKGROUND

Spare parts lists of non-standard formats may be transferred from machine and/or equipment manufacturers to other divisions separately, such as to control and/or production engineering divisions, without undergoing a process to check accuracy and completeness of the lists.

Accordingly, a need exists for alternative tools to build and compile spare parts lists and methods of use of such tools.

### SUMMARY

In one embodiment, a method for standardizing spare parts lists may include uploading one or more spare parts lists to a central portal, providing access to a respective level of the central portal based on a security clearance level, standardizing the one or more spare parts lists via the central portal, storing the one or more standardized spare parts lists in a database associated with the central portal, releasing the one or more standardized spare parts lists, displaying the one or more standardized spare parts lists on a graphical user interface communicatively coupled to the central portal, and displaying on the graphical user interface a first asset to inventory ratio report over a period of time of an asset to inventory ratio based at least in part on data from the standardized one or more spare parts lists. The access to a standardizing level of the central portal may be associated with an advanced security clearance level. The first asset to inventory ratio report may display the asset to inventory ratio associated with at least one of an industrial manufacturing site and a plurality of industrial manufacturing sites.

In another embodiment, a system may include one or more spare parts lists and a central portal, and a processor communicatively coupled to a non-transitory computer storage medium and the central portal, wherein the non-transitory computer storage medium stores instructions. When executed by the processor, the instructions may cause the processor to upload the one or more spare parts lists to the central portal, provide access to a respective level of the central portal based on a security clearance level, standardize the one or more spare parts lists via the central portal, store the one or more standardized spare parts lists in a database associated with the central portal, release the one or more standardized spare parts lists, display the one or more standardized spare parts lists on a graphical user interface communicatively coupled to the central portal, and display on the graphical user interface a first asset to inventory ratio report over a period of time of an asset to inventory ratio based at least in part on data from the standardized one or more spare parts lists. The access to a standardizing level of the central portal may be associated with an advanced security clearance level. The first asset to inventory ratio report may display the asset to inventory ratio associated with at least one of an industrial manufacturing site and a plurality of industrial manufacturing sites.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a flow chart of a process for using a spare parts list builder and compiler tool based on a basic security clearance access, according to one or more embodiments shown and described herein;

FIG. 2 is a flow chart of a process for using a spare parts list builder and compiler tool based on an advanced security clearance access, according to one or more embodiments shown and described herein;

FIG. 3 schematically illustrates a system for implementing computer and software based methods to utilize the list builder and compiler tools of FIGS. 1 and/or 2 based on a security clearance level, according to one or more embodiments shown and described herein; and

FIG. 4 depicts an exemplary plot report displaying an asset to inventory ratio over a period of time, according to one or more embodiments shown and described herein.

### DETAILED DESCRIPTION

Referring generally to the figures, embodiments of the present disclosure are directed to a spare parts list compiler and builder application tool that includes a central portal to receive and coordinate spare parts lists from machine and/or equipment manufacturers by allowing them to upload spare parts lists into a centralized system that may include, for example, a web server. These lists may be uploaded in a standardized format via the central portal. A centralized division with advanced security access may review and/or update the uploaded spare parts list(s) before (and/or after) releasing the list(s) for viewing and/or use by other divisions. The centralized division may, for example, verify components on the lists, add information, and/or create new lists prior to releasing the lists for viewing by and/or transfer to others via the web server.

The central portal may assist with a target goal to reduce new project inventory for a region as the central portal allows for a centralized platform in which machine and/or equipment manufacturers may upload and/or manage spare parts lists. Thus, the portal may effect a reduction in new project inventory while insuring data integrity, leading to a reportable reduced asset to inventory ratio based at least on the uploaded standardized lists versus asset to inventory ratios for conventional systems utilizing potentially non-consistent, non-standardized, outdated, and inaccurate spare parts lists. As used herein, the asset to inventory ratio is the amount of inventory divided by total assets. Various embodiments of the portal and methods for use of the portal are described in detail herein.

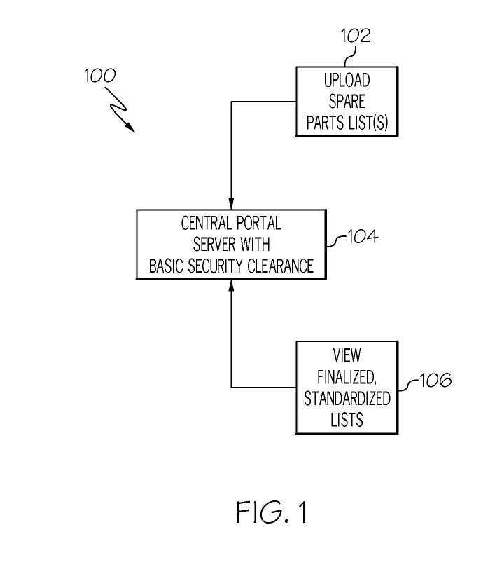

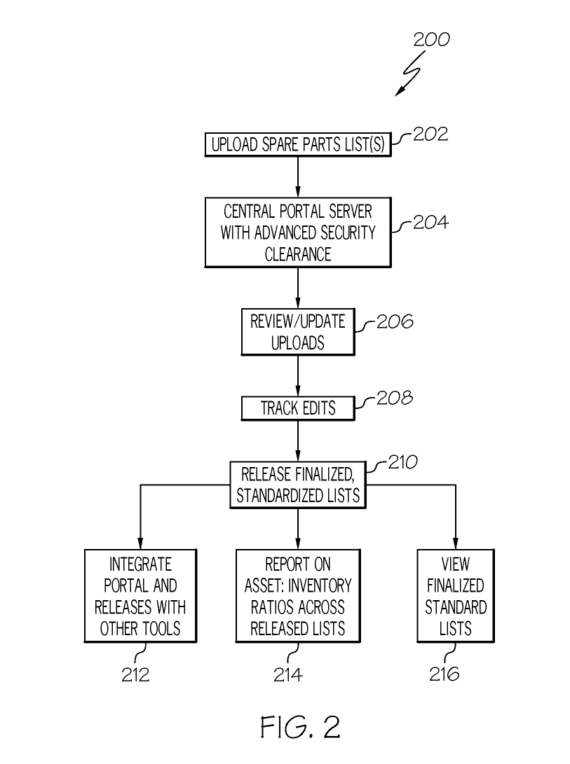

In embodiments, for example, a method for standardizing spare parts lists includes uploading one or more spare parts lists to a central portal, as shown in methods 100 and 200 of FIGS. 1 and 2, respectively, and described in greater detail further below. Based on a security clearance level, access is provided to a respective level of the portal. FIG. 1 illustrates a method 100 associated with a basic security clearance level, and FIG. 2 illustrates a method 200 associated with an advanced security clearance level. In embodiments, standardizing the one or more spare parts lists via the central portal is permitted upon access to a standardizing level of the portal that is associated with an advanced security clearance level. It should be understood that other security level types are possible and within the scope of this disclosure. For example, in embodiments, the central portal may include security for data submission and uploading, such as requiring a login for another advanced level of file submissions that may bypass a standardized list builder and compiler process.

In embodiments, the one or more standardized spare parts lists are stored in a database associated with the central portal and released to be displayed on a graphical user interface (GUI) communicatively coupled to the central portal. The standardized lists are released along with asset to inventory ratio reports over a period of time of an asset to inventory ratio that is based at least in part on data from the standardized one or more spare parts lists. Further, the asset to inventory ratio report is displayable on a GUI for at least one of an industrial manufacturing site and a plurality of industrial manufacturing sites. It should be understood that other inventory based reporting types are displayable and are within the scope of this disclosure.

FIG. 1 depicts an exemplary method 100 of use of a central portal as described herein for a basic level user. For example, in step 102, one or more spare parts lists are uploaded into a central portal. Step 104 processes the upload as being made by a user having a basic security clearance, which does not permit the user to edit the uploaded spare parts list(s) from step 102 and/or any other uploaded spare parts list(s). In step 106, the user is able to view the one or more spare parts lists that are in a finalized, standardized form after such standardized one or more spare parts lists are released from the central portal for viewing. The standardized one or more spare parts lists may be viewable on a GUI, for example, which is described further below.

FIG. 2 depicts an exemplary method 200 of use of the central portal as described herein for an advanced level user. For example, in step 202, one or more spare parts lists are uploaded into a central portal. Step 204 processes the upload as being made by a user having an advanced security clearance, which permits the user to edit the uploaded spare parts list(s) from step 102 and/or any other uploaded spare parts list(s).

In step 206, a permitted advanced user is able to review and update the uploaded spare parts list(s) from step 202 and/or any other uploaded spare parts list(s). A part(s) scrub may be incorporated as the list is being built via an integrated review process by a centralized division to which an advanced user may belong (i.e., the scrub may clean the list and make sure it is a suitable reflection of a spare parts inventory). Further, the central portal may allow for checks on data consistency and the like and may provide email notices regarding such matters. The central portal may also include algorithms directed to automated standardization that may be used in conjunction with or instead of such manual standardization by a user. For example, such algorithms of the central portal may automatically place uploads into a set font and/or style, and/or may not permit uploads until they are placed in such predetermined standardized fonts and/or styles. Additionally or alternatively, such algorithms of the central portal may automatically indicate and notify one or more users of errors such as empty spaces to fill in on such reports, and of data inaccuracies per comparisons with one or more previously stored spare parts lists. Additionally or alternatively, such algorithms of the central portal may automatically fill in missing information such as date and time of submission or upload if not previously entered. In embodiments, via the central portal, the uploaded one or more spare parts lists are comparable against stock levels across the plurality of industrial manufacturing sites and/or at a single industrial manufacturing site via the central portal.

Thus, in embodiments, standardizing the one or more uploaded spare parts lists may include reviewing the uploaded one or more spare parts lists for data accuracy, updating the uploaded one or more spare parts lists to at least one of correct for inaccuracies and place the uploaded one or more spare parts list in a standardized form, and tracking updates made to the uploaded one or more spare parts lists. Further, the updating may include at least one of adding, deleting, and substituting data within the uploaded one or more spare parts lists. And the tracking of updates may include associating at least one of a user and a timestamp with each update.

In step 208, for example, the central portal is able to track edits of the permitted advanced user made in step 208 as well as timestamp the edits and track the user identity. Thus, the portal may track and keep records of edits such as by whom an edit was made and at what date and time. In some embodiments, at least one of the one or more standardized spare parts lists may be modified by a user having the advanced level of security clearance. Such modifications may be tracked as well such that the user identity and/or timestamp of the modification, as well as the modification, is recorded.

In step 210, the standardized, updated uploaded spare parts list(s) may be released, for example, for viewing in the method of FIG. 1. In embodiments, notifications are provided based on at least data from the one or more standardized spare parts lists. In embodiments, the released spare parts list(s) may be displayed on and/or accessible via a GUI.

In step 212, the standardized, updated uploaded spare parts list(s) along with the central portal may be integrated with other tools. In embodiments, the central portal may be incorporated with one or more inventory tracking tools. In embodiments, the central portal may be synchronized with one or more inventory tracking tools and notifications such as emails or other alerts may be provided to one or more users based on at least data from the one or more standardized spare parts lists and the data from the synchronization. For example, the portal may interface with various inventory programs including IBM MAXIMO ASSET MANAGEMENT and ORACLE PEOPLES OFT APPLICATIONS and may include functionality to provide email reminders in accordance with project milestones. It should be understood that the central portal may be integrated with other like inventory management tools. In embodiments, the portal may import existing IBM MAXIMO ASSET MANAGEMENT parts lists for modification jobs and/or be synchronized weekly with ORACLE PEOPLESOFT APPLICATIONS inventory and be compared against stock levels to check for and/or report upon data accuracy.

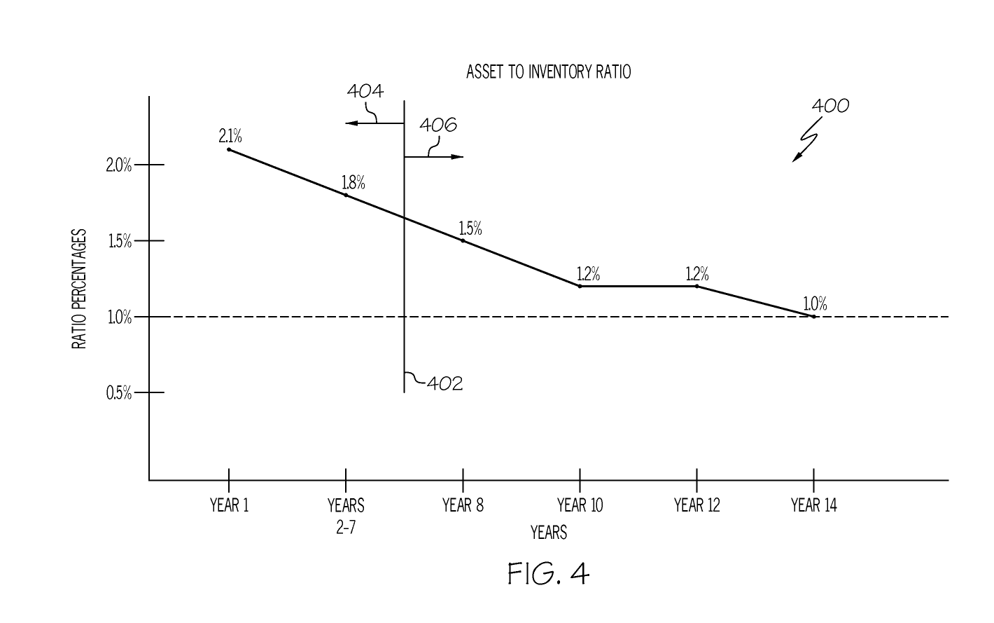

In step 212, the central portal may display a report on a GUI showing asset to inventory ratios based at least in part on released, standardized spare parts list(s) across a plurality of industrial sites, as described in greater detail further below with reference to FIG. 4. Such a report may be narrowed, filtered, or drilled down upon to show other reports of asset to inventory ratios based at least in part on the released, standardized spare parts list(s) across a portion of the plurality of industrial sites or on at least one of the industrial sites. For example, the plurality of industrial sites may be spread across worldwide manufacturing plants, the portion of the plurality of industrial sites may be narrowed to a geographical region (or be selected by other differentiating options, such as by a specific type of manufacturing site, whether it is for a specific automotive application or type of manufacture), and the at least one industrial site may show an asset to inventory ratio over time for a single industrial site.

By allowing for such narrowing, filterable asset to inventory ratio reporting, plant or manufacturing managers, for example, can track trends across such sites and focus on potential inventory issues at a specific site or group of sites. In embodiments, a first asset to inventory ratio report may display the asset to inventory ratio for the plurality of industrial manufacturing sites, and a second asset to inventory ratio report may display the asset to inventory ratio for a portion of industrial manufacturing sites of the plurality of industrial manufacturing sites, which portion is associated with a geographical region. A third asset to inventory ratio report may display the asset to inventory ratio for one industrial manufacturing site of the plurality of industrial manufacturing sites. In some embodiments, the first asset to inventory ratio report may display the asset to inventory ratio for the plurality of industrial manufacturing sites, and a second asset to inventory ratio report may display the asset to inventory ratio for a selected at least one industrial manufacturing site of the plurality of industrial manufacturing sites. In embodiments, the first asset to inventory ratio report displays a reduction in the asset to inventory ratio over the period of time.

In step 216, the user is able to view the one or more spare parts lists in a finalized, standardized form after the standardized one or more spare parts lists are released from the central portal for viewing. The standardized one or more spare parts lists may be viewable on a GUI, for example. The user may additionally or alternatively view other reports based at least in part on the released, standardized one or more spare parts lists and that may be displayed by the central portal and that are within the scope of this disclosure. For example, a report on milestone information based at least in part on data from the standardized one or more spare parts lists may be displayed on a GUI.

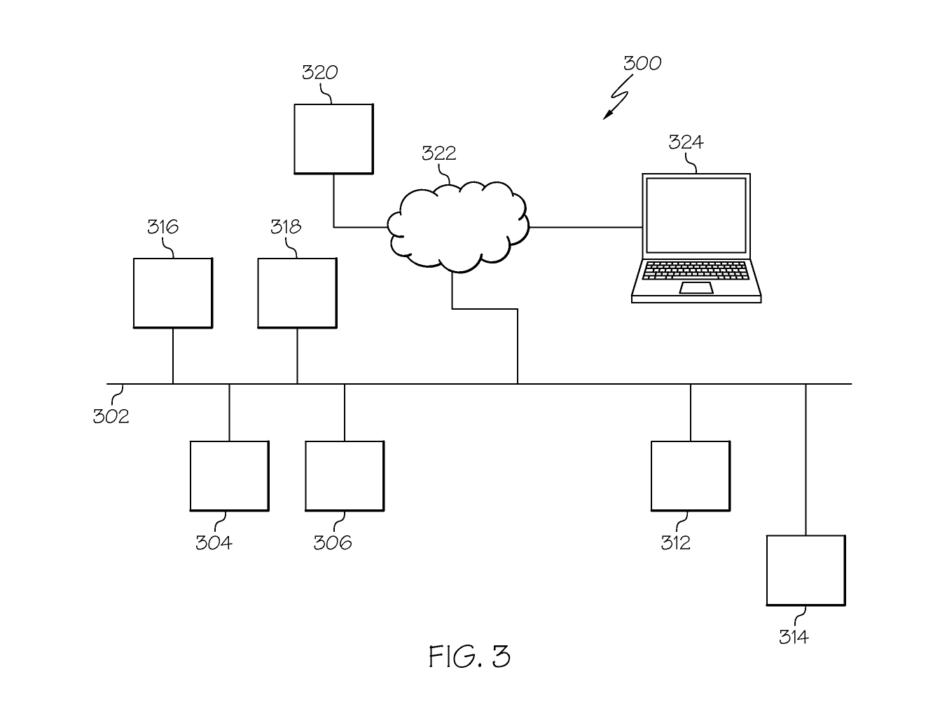

Referring to FIG. 3, a system 300 for implementing a computer and software-based method to utilize the list builder and compiler tools, as shown in FIGS. 1 and 2, is illustrated as being implemented along with using a GUI that is accessible at a user workstation (e.g., a computer 324), for example. The system 300 includes a communication path 302, one or more processors 304, a memory component 306, a tool integration component 312, a storage or database 314, a security clearance component 316, a network interface hardware 318, a network 322, a server 320, and at least one computer 324. The various components of the system 300 and the interaction thereof will be described in detail below.

While only one application server 320 and one user workstation computer 324 is illustrated, the system 300 can include multiple workstations and application servers containing one or more applications that can be located at geographically diverse locations across a plurality of industrial sites. In some embodiments, the system 300 is implemented using a wide area network (WAN) or network 322, such as an intranet or the Internet. The workstation computer 324 may include digital systems and other devices permitting connection to and navigation of the network. Other system 300 variations allowing for communication between various geographically diverse components are possible. The lines depicted in FIG. 3 indicate communication rather than physical connections between the various components.

As noted above, the system 300 includes the communication path 302. The communication path 302 may be formed from any medium that is capable of transmitting a signal such as, for example, conductive wires, conductive traces, optical waveguides, or the like, or from a combination of mediums capable of transmitting signals. The communication path 302 communicatively couples the various components of the system 300. As used herein, the term “communicatively coupled” means that coupled components are capable of exchanging data signals with one another such as, for example, electrical signals via conductive medium, electromagnetic signals via air, optical signals via optical waveguides, and the like.

As noted above, the system 300 includes the processor 304. The processor 304 can be any device capable of executing machine readable instructions. Accordingly, the processor 304 may be a controller, an integrated circuit, a microchip, a computer, or any other computing device. The processor 304 is communicatively coupled to the other components of the system 300 by the communication path 302. Accordingly, the communication path 302 may communicatively couple any number of processors with one another, and allow the modules coupled to the communication path 302 to operate in a distributed computing environment. Specifically, each of the modules can operate as a node that may send and/or receive data.

As noted above, the system 300 includes the memory component 306 which is coupled to the communication path 302 and communicatively coupled to the processor 304. The memory component 306 may be a non-transitory computer readable medium or non-transitory computer readable memory and may be configured as a nonvolatile computer readable medium. The memory component 306 may comprise RAM, ROM, flash memories, hard drives, or any device capable of storing machine readable instructions such that the machine readable instructions can be accessed and executed by the processor 304. The machine readable instructions may comprise logic or algorithm(s) written in any programming language such as, for example, machine language that may be directly executed by the processor, or assembly language, object-oriented programming (OOP), scripting languages, microcode, etc., that may be compiled or assembled into machine readable instructions and stored on the memory component 306. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Still referring to FIG. 3, as noted above, the system 300 comprises the display such as a GUI on a screen of the computer 324 for providing visual output such as, for example, information, graphical reports, messages, or a combination thereof. The display on the screen of the computer 324 is coupled to the communication path 302 and communicatively coupled to the processor 304. Accordingly, the communication path 302 communicatively couples the display to other modules of the system 300. The display can include any medium capable of transmitting an optical output such as, for example, a cathode ray tube, light emitting diodes, a liquid crystal display, a plasma display, or the like. Additionally, it is noted that the display or the computer 324 can include at least one of the processor 304 and the memory component 306. While the system 300 is illustrated as a single, integrated system in FIG. 3, in other embodiments, the systems can be independent systems.

The system 300 comprises the security clearance component 316 for determining a clearance level and access rights for a user and a tool integration component 312 to assist with integration of the system 300 with other tools as described above. The security clearance component 316 and the tool integration component 312 are coupled to the communication path 302 and communicatively coupled to the processor 304. As will be described in further detail below, the processor 304 may process the input signals received from the system modules and/or extract information from such signals.

The system 300 includes the network interface hardware 318 for communicatively coupling the system 300 with a computer network such as network 322. The network interface hardware 318 is coupled to the communication path 302 such that the communication path 302 communicatively couples the network interface hardware 318 to other modules of the system 300. The network interface hardware 318 can be any device capable of transmitting and/or receiving data via a wireless network. Accordingly, the network interface hardware 318 can include a communication transceiver for sending and/or receiving data according to any wireless communication standard. For example, the network interface hardware 318 can include a chipset (e.g., antenna, processors, machine readable instructions, etc.) to communicate over wired and/or wireless computer networks such as, for example, wireless fidelity (Wi-Fi), WiMax, Bluetooth, IrDA, Wireless USB, Z-Wave, ZigBee, or the like.

Still referring to FIG. 3, data from various applications running on computer 324 can be provided from the computer 324 to the system 300 via the network interface hardware 318. The computer 324 can be any device having hardware (e.g., chipsets, processors, memory, etc.) for communicatively coupling with the network interface hardware 318 and a network 322. Specifically, the computer 324 can include an input device having an antenna for communicating over one or more of the wireless computer networks described above.

The network 322 can include any wired and/or wireless network such as, for example, wide area networks, metropolitan area networks, the Internet, an Intranet, satellite networks, or the like. Accordingly, the network 322 can be utilized as a wireless access point by the computer 324 to access one or more servers (e.g., a server 320). The server 320 and any additional servers generally include processors, memory, and chipset for delivering resources via the network 322. Resources can include providing, for example, processing, storage, software, and information from the server 320 to the system 300 via the network 322. Additionally, it is noted that the server 320 and any additional servers can share resources with one another over the network 322 such as, for example, via the wired portion of the network, the wireless portion of the network, or combinations thereof.

Referring to FIG. 4, and as described above, the system 300 may interact with the methods 100 and 200 of the list builder and compiler tool described herein to report on results across a plurality of released, standardized spare parts lists. FIG. 4 shows a non-limiting example of such a first asset to inventory ratio report 400. The x-axis includes a time range extending from years 1 through 14. The y-axis shows asset to inventory ratio percentages. Line 402 shows a split of results, such that in the direction of arrow 404 from line 402, results are shown from a period of time when a list builder and compiler tool as described herein is not in use. And in the direction of arrow 406 from line 402, results are shown from a period of time when the list builder and compiler tool as described herein is in use.

The report 400 indicates that the asset to inventory ratio was more quickly reduced during a period of time divided by line 402, such that use of the list builder tool described herein effected a more rapid reduction in an asset to inventory ratio. For example, with respect to the direction of arrow 404 from line 402 during years 1-7, when a list builder and compiler builder tool as described herein is not in use to standardize, review, and edit spare parts lists, year 1 shows a ratio percentage of about 2.1%, and year's 2-7 generally remains at a ratio percentage of about 1.8%. After utilizing the list builder and compiler tool as described herein, however, to standardize, review, and edit spare parts lists from the point of line 402, and as shown with respect to the direction of arrow 406, year 8 shows a rapid drop to about 1.5%, followed by another drop over time to about 1.2% in year 10, remaining at level until year 12, and then a reduction to about 1.0% in year 14.

Thus, the central portal of a list builder and compiler tool as described herein may assist with a target goal to reduce new project inventory for a region including a plurality of industrial sites and/or at a single industrial site as it allows for a centralized platform in which machine and/or equipment manufacturers may upload and/or manage spare parts list. While insuring data integrity by allowing for permitted edits to upload lists create a database of standardized, accurate, and consistent spare parts lists, the central portal may effect a reduction in new project inventory, leading to a reduced asset to inventory ratio over conventional systems based on potentially non-consistent, non-standardized, outdated, and inaccurate spare parts lists.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for standardizing spare parts lists, the method comprising:
uploading one or more spare parts lists to a central portal;
based on a security clearance level, providing access to a respective level of the central portal;
standardizing the one or more spare parts lists via the central portal, wherein the access to a standardizing level of the central portal is associated with an advanced security clearance level;
storing the one or more standardized spare parts lists in a database associated with the central portal;
releasing the one or more standardized spare parts lists;
displaying the one or more standardized spare parts lists on a graphical user interface communicatively coupled to the central portal; and
displaying on the graphical user interface a first asset to inventory ratio report over a period of time of an asset to inventory ratio based at least in part on data from the standardized one or more spare parts lists, wherein the first asset to inventory ratio report displays the asset to inventory ratio associated with at least one of an industrial manufacturing site and a plurality of industrial manufacturing sites.

2. The method of claim 1, wherein when the security clearance level is the advanced security clearance level, standardizing the one or more spare parts lists via the central portal permits user access and further comprises:
reviewing the uploaded one or more spare parts lists for data accuracy;
updating the uploaded one or more spare parts lists to at least one of correct for inaccuracies and place the uploaded one or more spare parts list in a standardized form; and
tracking updates made to the uploaded one or more spare parts lists.

3. The method of claim 2, wherein updating comprises at least one of adding, deleting, and substituting data within the uploaded one or more spare parts lists.

4. The method of claim 2, wherein tracking updates comprises associating at least one of a user identity and a timestamp with each update.

5. The method of claim 1, further comprising:
via the central portal, comparing the uploaded one or more spare parts lists against stock levels across the plurality of industrial manufacturing sites.

6. The method of claim 1, further comprising:
via the central portal, comparing the uploaded spare parts lists against stock levels at the industrial manufacturing site.

7. The method of claim 1, further comprising displaying a report on milestone information based at least in part on data from the standardized one or more spare parts lists.

8. The method of claim 1, wherein the first asset to inventory ratio report displays the asset to inventory ratio for the plurality of industrial manufacturing sites, and wherein a second asset to inventory ratio report displays the asset to inventory ratio for a portion of industrial manufacturing sites of the plurality of industrial manufacturing sites, wherein the portion is associated with a geographical region.

9. The method of claim 8, wherein a third asset to inventory ratio report displays the asset to inventory ratio for one industrial manufacturing site of the plurality of industrial manufacturing sites.

10. The method of claim 1, wherein the first asset to inventory ratio report displays the asset to inventory ratio for the plurality of industrial manufacturing sites, and wherein a second asset to inventory ratio report displays the asset to inventory ratio for a selected at least one industrial manufacturing site of the plurality of industrial manufacturing sites.

11. The method of claim 1, wherein the security clearance level is at least one of a basic security clearance level and the advanced security clearance level.

12. The method of claim 1, wherein the first asset to inventory ratio report displays a reduction in the asset to inventory ratio over the period of time.

13. The method of claim 1, further comprising incorporating the central portal with one or more inventory tracking tools.

14. The method of claim 1, further comprising providing notifications based on at least data from the one or more standardized spare parts lists.

15. The method of claim 1, further comprising synchronizing the central portal with one or more inventory tracking tools and providing notifications based on at least data from the one or more standardized spare parts lists and data from the synchronization.

16. The method of claim 1, further comprising modifying at least one of the one or more standardized spare parts lists based on the advanced security clearance level.

17. A system comprising:
one or more spare parts lists and a central portal; and
a processor communicatively coupled to a non-transitory computer storage medium and the central portal, wherein the non-transitory computer storage medium stores instructions that, when executed by the processor, cause the processor to:
upload the one or more spare parts lists to the central portal;
based on a security clearance level, provide access to a respective level of the central portal;
standardize the one or more spare parts lists via the central portal, wherein the access to a standardizing level of the central portal is associated with an advanced security clearance level;
store the one or more standardized spare parts lists in a database associated with the central portal;
release the one or more standardized spare parts lists;
display the one or more standardized spare parts lists on a graphical user interface communicatively coupled to the central portal; and
display on the graphical user interface a first asset to inventory ratio report over a period of time of an asset to inventory ratio based at least in part on data from the standardized one or more spare parts lists, wherein the first asset to inventory ratio report displays the asset to inventory ratio associated with at least one of an industrial manufacturing site and a plurality of industrial manufacturing sites.

18. The system of claim 17, wherein the first asset to inventory ratio report displays a reduction in the asset to inventory ratio over the period of time.

19. The system of claim 17, wherein the security clearance level is at least one of a basic security clearance level and the advanced security clearance level.

20. The system of claim 17, wherein the instruction to display on the graphical user interface a first asset to inventory ratio report comprises instructions to display the asset to inventory ratio associated with and across the plurality of industrial manufacturing sites, and further comprising instructions to:
display a second asset to inventory ratio report over the period of time of a second asset to inventory ratio based at least in part on data from the standardized one or more spare parts lists, wherein the second asset to inventory ratio is associated with a selected at least one industrial manufacturing site of the plurality of industrial manufacturing sites.
